(19) United States
(12) Patent Application Publication
(10) Pub. No.: US 2025/0232303 A1
(43) Pub. Date: Jul. 17, 2025

(54) SYSTEMS AND METHODS FOR FRAUD PREVENTION VIA ENHANCED TRANSACTION MESSAGES

(71) Applicant: Capital One Services, LLC, McLean, VA (US)

(72) Inventors: Jeffrey RULE, Chevy Chase, MD (US); Kevin OSBORN, Newton Highlands, MA (US)

(21) Appl. No.: 18/410,268

(22) Filed: Jan. 11, 2024

(51) Int. Cl. G06Q 20/34; G06Q 20/40

(52) U.S. Cl. CPC G06Q 20/4016; G06Q 20/352; G06Q 2220/00

(57) ABSTRACT

Systems and methods of fraud prevention are provided. An exemplary system comprises a server including a memory and a processor. The server is configured to receive a transaction message of a contactless card, the transaction message including an Europay, Mastercard, and Visa (EMV) identifier, receive a unique card identifier and a cryptographic payload of the contactless card, and incorporate the unique card identifier and the cryptographic payload into the transaction message to generate an enhanced transaction message. The server is further configured to determine whether the EMV identifier pairs with the unique card identifier, and determine whether to transmit the enhanced transaction message to a transaction processing device for processing the enhanced transaction message.

### FIELD OF THE INVENTION

The present disclosure relates generally to data security, and more particularly, to systems and methods for enhancing transaction messages for fraud prevention.

### BACKGROUND

Data security and transaction integrity are of critical importance to businesses and consumers. Fraudulent actors will frequently try to exploit vulnerabilities in data storage, data transmission, and user authentication to perform fraudulent transactions. Fraudulent transactions can be very costly and disruptive for businesses and consumers, and attempts by fraudulent actors to perform fraudulent transactions or other fraudulent activity are increasing.

To counter fraud, customers are usually authenticated using multiple factors when transactions are being conducted. For example, email may be used as one authentication factor to verify customers and/or transactions. As another example, short message service (SMS) messages may also be used. However, those authentication factors involve the customers to perform extra interactions, which can delay transaction processing and inconvenience the customers, and also have security vulnerabilities that fraudulent actors can exploit.

These and other deficiencies exist. Accordingly, there is a need to provide systems and methods that overcome these deficiencies to further authenticate a user using additional factors that do not require extra interactions from the user.

### SUMMARY

Aspects of the disclosed technology include systems and methods of enhancing transaction messages for fraud prevention.

Embodiments of the present disclosure provide a method for fraud prevention. The method comprises: receiving a transaction message of a contactless card, the transaction message including an Europay, Mastercard, and Visa (EMV) identifier; receiving a unique card identifier and a cryptographic payload of the contactless card; incorporating the unique card identifier and the cryptographic payload into the transaction message to generate an enhanced transaction message; determining whether the EMV identifier pairs with the unique card identifier; and determining whether transmit the enhanced transaction message to a transaction processing device for processing the enhanced transaction message.

Embodiments of the present disclosure provide a system for fraud prevention. The system comprises a server including a memory and a processor. The server is configured to: receive a transaction message of a contactless card, the transaction message including an Europay, Mastercard, and Visa (EMV) identifier, receive a unique card identifier and a cryptographic payload of the contactless card, incorporate the unique card identifier and the cryptographic payload into the transaction message to generate an enhanced transaction message, determine whether the EMV identifier pairs with the unique card identifier, and determine whether to transmit the enhanced transaction message to a transaction processing device for processing the enhanced transaction message.

Embodiments of the present disclosure provide a non-transitory, computer-readable medium comprising instructions for fraud prevention that, when executed on a computer arrangement, perform actions comprising: receiving a transaction message of a contactless card, the transaction message including an Europay, Mastercard, and Visa (EMV) identifier; receiving a unique card identifier and a cryptographic payload of the contactless card; incorporating the unique card identifier and the cryptographic payload into the transaction message to generate an enhanced transaction message; determining whether the EMV identifier pairs with the unique card identifier; and determining whether to transmit the enhanced transaction message to a transaction processing device for processing the enhanced transaction message.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for enhancing transaction messages for fraud prevention according to an example embodiment.

FIG. 2 is a diagram of a sequence of interactions between components of the system in FIG. 1 according to an example embodiment.

FIG. 3A is a contactless card that can be used for enhancing transaction messages for fraud prevention according to an example embodiment.

FIG. 3B is a diagram of the processor of the contactless card in FIG. 3A according to an example embodiment.

FIG. 4 is a flow chart of a method for enhancing transaction messages for fraud prevention according to an example embodiment.

FIG. 5 is a flow chart of a method for enhancing transaction messages for fraud prevention according to an example embodiment.

FIG. 6 is a flow chart of a method for enhancing transaction messages for fraud prevention according to an example embodiment.

FIG. 7 is a flow chart of a method for enhancing transaction messages for fraud prevention according to an example embodiment.

FIG. 8 is a diagram of a system for enhancing transaction messages for fraud prevention according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

Example embodiments of the present disclosure provide systems and methods for enhancing transaction messages for fraud prevention. The present disclosure provides for adding a unique card identifier and a cryptographic payload of a contactless card to a transaction message of the contactless card. The transaction message may include an Europay, Visa, and Mastercard (EMV) identifier. The EMV identifier and the unique card identifier can be used to reduce fraud in the transaction flow. Specifically, example embodiments of the present disclosure can allow adding the unique card identifier and the cryptographic payload of the contactless card to the ISO20022 transaction message. The ISO20022 standard method was adopted in 2021 and is extensible Markup Language (XML) based and accordingly more flexible than previous standards.

For example, a customer may tap their card either at a point of sale (POS) or in a mobile transaction on a near-field communication (NFC) enabled mobile phone. The POS or mobile phone can read both the EMV applet and the unique card identifier and cryptographic payload applet. The merchant's payment processor can incorporate the unique card identifier and cryptographic payload into the ISO20022 transaction message along with normal transaction data (e.g., the EMV identifier).

Additionally, example embodiments of the present disclosure may include a switchboard that can provide a nonce that is sent back to the POS or mobile phone and is incorporated back into the transaction message returned to the switchboard.

The enhanced transaction message including the unique card identifier, the cryptographic payload, transaction data including the EMV identifier, and/or the nonce can be sent from the merchant's processor to a transaction processing entity, e.g., an acquiring bank.

The transaction processing entity can use the unique card identifier and EMV relationship to see if the unique card identifier and the EMV identifier have been paired together in the past. The unique card identifier paired with new EMV identifiers can be considered a fraud signal. Additionally, the transaction processing entity can also transmit the cryptographic payload to a validation entity (e.g., a validator) to validate the cryptographic payload.

In a transaction, the payment processing network (e.g., the credit card network) receives the enhanced IS20022 transaction message from the transaction processing entity. Because payment processing networks usually experience a larger volume of traffic than the transaction processing entity, the payment processing networks can again match the EMV identifier to the unique card identifier to confirm the relationship between these two identifiers. The presence of the unique card identifier also implies that authentication the cryptographic payload was used which reduces the possibility of fraud.

The card issuers (e.g., issuing banks) would have already been involved in validating the cryptographic payload and the unique card identifier and will be looking for the same cryptographic payload and unique card identifier in the incoming transaction data (e.g., the enhanced IS20022 transaction message). The Issuing bank can significantly reduce fraud by knowing that the two identifiers match.

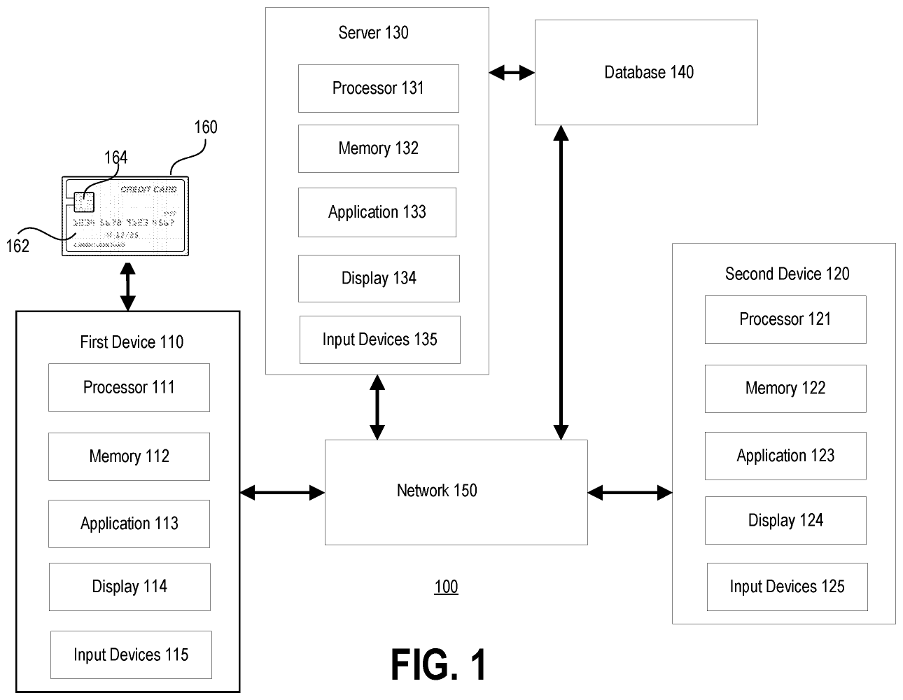

FIG. 1 illustrates a system 100 for enhancing transaction messages for fraud prevention according to an example embodiment. As further discussed below, the system 100 may include a first device 110, a second device 120, a server 130, a database 140 in communication using a network 150, and a contactless card 160 in signal communication with the second device 120. Although FIG. 1 illustrates single instances of the components, the system 100 may include any number of components.

The first device 110 may be associated with a merchant with which a transaction is conducted by a user, for example, a PoS from the merchant. Alternatively, the first device 110 may be associated with the user, for example, a mobile phone of the user to which a contactless card can be tapped via NFC. If the first device 110 is associated with a merchant, the first device 110 can be configured to store the online merchant accounts, and to present a shopping interface on which the user can conduct the transactions with the merchant.

The first device 110 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the first device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the first device 110. In some examples, the first device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. For example, the application 113 may be executed to perform authenticating the user or sending an authentication request of authenticating the user. The application 113 may also be executed to perform processing transactions of a user who may shop online from the merchant. Such processes may be implemented in software, such as software modules, for execution by computers or other machines. The application 113 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The first device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the first device 110 that is available and supported by the first device 110, such as a touch-screen, keyboard, mouse, cursor-control device, microphone, digital camera, video recorder or camcorder. These devices may be used to enter information and interact with the software and other devices described herein.

The second device 120 can be used by the merchant, the merchant's payment processor or the BA of the merchant to perform transactions with the first device 110. For example, the second device 120 may be a backend server associated with the merchant, the merchant's payment processor or the BA of the merchant.

The second device 120 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 120 may include a processor 121, a memory 122, an application 123, a display 124, and input devices 125. The processor 121 may be a processor, a microprocessor, or other processor, and the second device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the second device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the second device 120. In some examples, the second device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The second device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the second device 120 that is available and supported by the second device 120, such as a touch-screen, keyboard, mouse, cursor-control device, microphone, digital camera, video recorder or camcorder. These devices may be used to enter information and interact with the software and other devices described herein such as selecting an option of creating an online account with the merchant.

The server 130 may be associated with an institution, such as a financial institution that issues the contactless card 160, or the Credit Card Network, and can be configured to communicate with the first device 110 and/or the second device 120. The institution associated with the server 130 may issue the contactless card 160 to the user and accordingly may authenticate the user based on the contactless card 160.

The server 130 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, a card authentication module of the application 133 may be executed to perform authenticating the user based on the contactless card 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, microphone, digital camera, video recorder or camcorder. These devices may be used to enter information and interact with the software and other devices described herein.

The database 140 may be one or more databases configured to store date, including without limitation, private information of users, financial accounts of users, contactless card information, online merchant account information, transactions of users, and merchant records indicative of corresponding merchants. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the first device 110, the second device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the first device 110, server 130, and second device 120 using the network 150 can occur using one or more front channels and one or more secure back channels. A front channel may be a communication protocol that employs a publicly accessible and/or unsecured communication channel such that a communication sent to the first device 110, server 130, and/or second device 120 may originate from any other device, whether known or unknown to the first device 110, server 130, and/or second device 120, if that device possesses the address (e.g., network address, Internet Protocol (IP) address) of the first device 110, server 130, and/or second device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the first device 110, server 130, and/or second device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card 160 may be any type of card, such as a security card, a payment card, an identification card, and the like. The contactless card 160 may be issued to the user by the financial institution for identity verification for the bank account of the user.

The contactless card 160 can be configured to transmit a unique card identifier and a cryptographic payload including a cryptogram to the first device 110 upon tapping to the first device 110. The first device 110 may be configured to read the unique card identifier and the cryptographic payload including the cryptogram from the contactless card 160 after entry of the contactless card 160 into a communication field of the first device 110. The first device 110 may then transmit the unique card identifier and the cryptographic payload including the cryptogram to the second device 120.

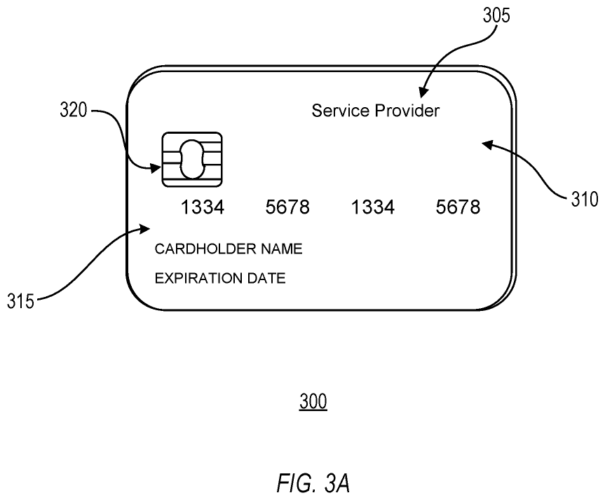

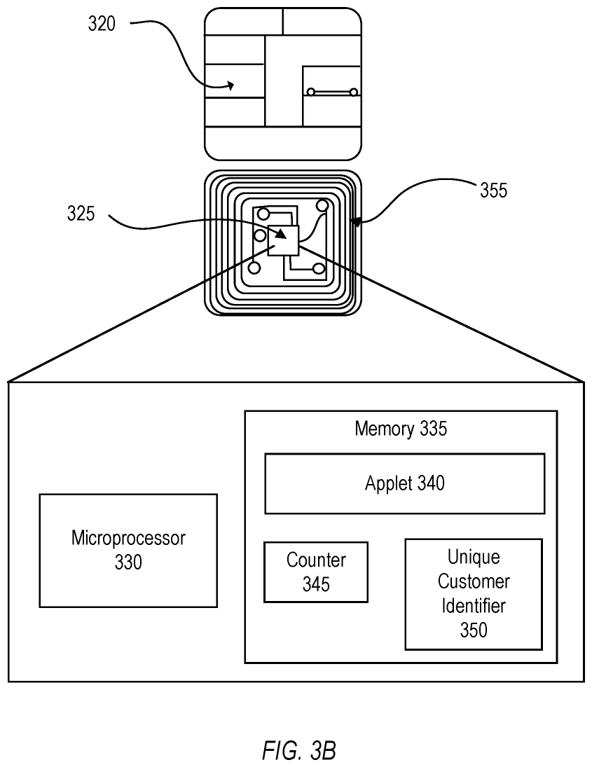

The contactless card 160 can perform authentication and numerous other functions that may otherwise require a user to carry a separate physical token in addition to the contactless card 160. By employing a contactless interface, the contactless card 160 may be provided with a method to interact and communicate between a user's device (such as a mobile phone or the first device 110) and the card itself. For example, the Europay, Mastercard, and Visa (EMV) protocol, which underlies many credit card transactions, includes an authentication process which suffices for operating systems for Android® and for iOS®, For IOS®, sending commands to the EMV applet is not allowed unless by a special Apple® partner, but writing to the EMV is permitted, which is required for the nonce operation with switchboard described later. Exemplary embodiments of the contactless card 160 described herein utilize NFC technology. The contactless card 160 may comprise a substrate 162 and a contact pad 164. Details of an example contactless card will be described in FIGS. 3A and 3B.

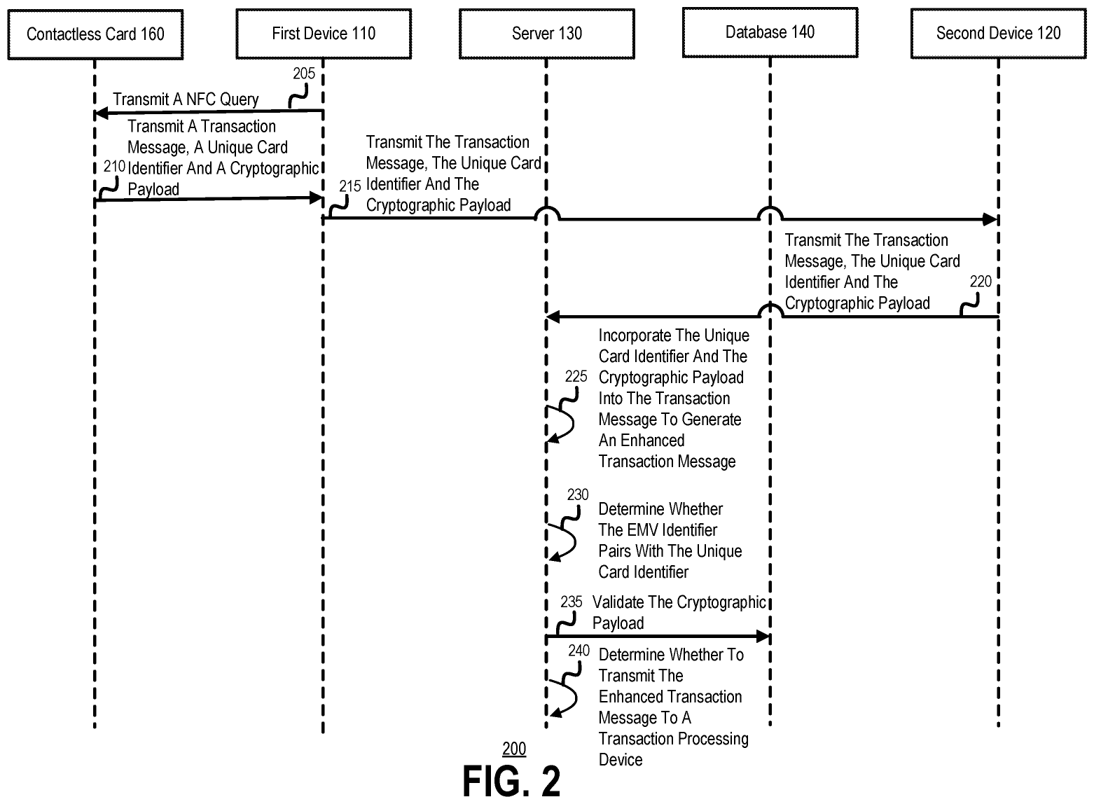

FIG. 2 illustrates an example diagram 200 of sequence of interactions between the components of the system 100 according to an example embodiment. FIG. 2 may reference the same or similar components as those illustrated in FIG. 1, including a first device, a server, a database, a second device and a contactless card.

When a user wants to make a purchase from a merchant, the user may use the first device 110. For example, the user may tap the contactless card 160 to the first device 110. Upon tapping the contactless card 160, at step 205, the first device 110 may transmit an NFC prompt and/or query to the contactless card 160. The first device 110 may include an NFC interface configured for establishing an NFC communication with other NFC-equipped devices (the contactless card 160 in this embodiment). In some of these embodiments, the NFC interface of the first device 110 may be or include an NFC receiver configured for selectively activating a magnetic field for use in establishing near field communication with an NFC transmitter. The NFC interface of the first device 110 is configured for establishing NFC communication when a passive NFC tag or other NFC-enabled device is brought into the magnetic field and within the NFC communication range of the first device 110. The NFC interface of the first device 110 is configured, in particular, for communication with the NFC-enabled card 160 when the contactless card 160 is brought within communication range of the first device 110 (such as, the contactless card 160 is tapped by the user to the first device 110). As used herein, a tap of the contactless card 160 to the first device 110 may not indicate that the contactless card 160 is in a physical contact with the first device 110. A tap of the contactless card 160 to the first device 110 may refer to entry of the contactless card 160 into the NFC communication field of the first device 110.

In response, at step 210, the contactless card 160 may transmit a transaction message, a unique card identifier, and a cryptographic payload to the first device 110. That is, the first device 110 can be configured to read the EMV applet of the contactless card 160 to get the transaction message and to read the cryptographic payload applet of the contactless card 160 to obtain the unique card identifier, and the cryptographic payload. The cryptographic payload may include, for example, security information (e.g., a cryptogram) encrypted by the contactless card 160 using a private key unique to the contactless card 160 that is known only to the card account administrator (e.g., the server 130).

At step 215, the first device 110 may transmit the transaction message, the unique card identifier, and the cryptographic payload to the second device 120. At step 220, the second device 120 may then transmit the transaction message, the unique card identifier, and the cryptographic payload to the server 130.

At step 225, the server 130 may incorporate the unique card identifier and the cryptographic payload into the transaction message to generate an enhanced transaction message. The transaction message is a transaction message format supported by ISO20022 transaction standard, which was adopted in 2021. The ISO20022 transaction standard is XML based and more flexible than previous standards. For example, the server 130, which may be associated with the merchant's payment processor, can incorporate the unique card identifier and the cryptographic payload into the ISO20022 transaction message along with normal transaction data (e.g., an EMV identifier of the contactless card 160).

At step 230, the server 130 may determine whether the EMV identifier pairs with the unique card identifier. For example, the server 130 may consult the database 140 to see whether the EMV identifier has been paired with the unique card identifier in the past (e.g., recent transaction history, all transaction history, certain time periods, etc.). If the EMV identifier and the unique card identifier matches, the server 130 can determine the EMV identifier pairs with the unique card identifier. If the EMV identifier is a new EMV identifier, the server 130 may determine the EMV identifier does not pair with the unique card identifier, and may then determine the transaction associated with the enhanced transaction message is a fraudulent transaction.

At step 235, the server 130 may further validate the cryptographic payload. The cryptographic payload includes a cryptogram. For example, the server 130 may generate another cryptogram based on information that is associated with the contactless card 160 and retrieved from the database 140. The server 130 may then compare the generated cryptogram with the received cryptogram from the cryptographic payload. If these two cryptograms are the same, the server 130 can determine this transaction is a real transaction, otherwise, it is determined to be a fraudulent transaction. The server 130 may also decrypt the cryptogram and extract the unique card identifier of the contactless card 160 that is also encrypted into the cryptogram. When the server 130 receives the cryptogram, the server may further decrypt the cryptogram after verifying and/or validating the cryptogram. The server 130 may then extract the unique card identifier of the contactless card 160. The server 130 may verify the unique card identifier of the contactless card 160 by searching the database 140. The server 130 may authenticate the user based on the unique card identifier of the contactless card 160.

At step 240, the server 130 may determine whether to transmit the enhanced transaction message to a transaction processing device for processing the enhanced transaction message. The transaction processing device is configured to process the enhanced transaction message to settle the transaction. For example, if the server 130 determines the EMV identifier pairs with the unique card identifier, which can indicate the transaction is a valid transaction, the server 130 can transmit the enhanced transaction message to the transaction processing device for processing the enhanced transaction message. Further, the server 130 may determine whether to transmit the enhanced transaction message to the transaction processing device for processing the enhanced transaction message, based on whether the cryptographic payload is validated at step 235. If the cryptographic payload is validated, the server 130 can transmit the enhanced transaction message to the transaction processing device for processing the enhanced transaction message. Otherwise, the server 130 can determine the transaction is a fraudulent transaction and does not transmit the enhanced transaction message to the transaction processing device for processing the enhanced transaction message.

In some embodiments, if the server 130 is associated with the issuer of the contactless card 160, the server 130 may not need to transmit the enhanced transaction message to the transaction processing device for processing the enhanced transaction message. Instead, the server 130 may be able to process the enhanced transaction message to complete the transaction.

As described above, the ISO 20022 standard is a new web-based transaction standard that allows to do transaction processing over the Internet. Because Internet transaction processing does not typically use the EMV authentication, it would enhance transaction security to add authentication by combining the unique card identifier and the cryptographic payload into the transaction message along with the payment information (e.g., credit card number, cardholder name, and card expiration date and/or security code on the card). The payment information can be incorporated into the transaction message through reading the card directly by a PoS or mobile phone, obtaining a virtual card number of the card, or manually entering the card number. The card may be prompted to tap to a mobile phone to actually incorporate the unique card identifier and the cryptographic payload for authentication into the transaction message to generate an enhanced transaction message.

In some embodiments, the cryptographic payload may include an issuer identifier of the issuing bank of the card, and the enhanced transaction message may be routed to the issuing bank of the card that can actually validate the unique card identifier and the cryptographic payload. The issuing bank can then look up the corresponding credit card account and determine that the unique card identifier and the cryptographic payload matches the card that is being preferred for the transaction.

In some embodiments, when prompting to tap the card, a nonce may be provided and then included in the transaction message. This would allow to match the nonce to the session that it comes from to increase data transmission security.

FIG. 3A describes a contactless card 300 that can be used for enhancing transaction message for fraud prevention in the system 100 of FIG. 1. For example, the contactless card 160 in FIG. 1 can be the contactless card 300 described herein. The contactless card 300 is configured to communicate with the first device 110 of system 100. The contactless card 300 may comprise a payment card, such as a credit card, debit card, or gift card, issued by a service provider 305 (such as a bank associated with the server 130) displayed on the front or back of the contactless card 300. In some examples, the contactless card 300 is not related to a payment card, and may comprise, without limitation, an identification card, a membership card, and a transportation card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, PoS, or tablet computer. The contactless card 300 may also include processing circuitry, antenna and other components. These components may be located behind the contact pad 320 or elsewhere on the substrate. The contactless card 300 may also include a magnetic strip or tape, or an EMV integrated circuitry chip, which may be located on the back of the contactless card 300.

FIG. 3B illustrates an example contact pad 320 of the contactless card 300. The contact pad 320 of the contactless card 300 may include processing circuitry 325 for storing and processing information, including a processor 330 and a memory 335. It is understood that the processing circuitry 325 may contain additional components, including processors, memories, error and parity/CRC checkers, data encoders, anticollision algorithms, controllers, command decoders, security primitives and tamperproofing hardware, as necessary to perform the functions described herein.

The memory 335 may be a read-only memory, write-once read-multiple memory or read/write memory, e.g., RAM, ROM, and EEPROM, and the contactless card 300 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some embodiments, the memory 335 may also have stored public and private card encryption keys. In some embodiments, the private and public encryption keys may be permanently hard-wired into the memory 335. In various embodiments, the memory 335 may have stored therein instructions for generating encrypted information and transmitting it to a receiving device (e.g., the first device 110). Such encrypted information may be or include an encrypted verification block or signature that may be used to authenticate and verify the presence of the card 300 during transaction processing. In some embodiments, encrypted information may be unique to a particular communication (e.g., a particular NFC transmission by the card 300).

The memory 335 may be configured to store one or more applets 340, one or more counters 345, and a unique customer identifier 350 (also referred to a unique card identifier as above). The one or more applets 340 may comprise one or more software applications configured to execute on one or more contactless cards, such as Java Card applet. However, it is understood that the one or more applets 340 are not limited to Java Card applets, and instead may be any software application operable on contactless cards or other devices having limited memory. The one or more applets 340 may comprise an EMV applet. The one or more counters 345 may comprise a numeric counter sufficient to store an integer. The unique customer identifier 350 may comprise a unique alphanumeric identifier assigned to a user of the contactless card 300, and the identifier may distinguish the user of the contactless card 300 from other contactless card users. In some examples, the customer identifier 350 may identify both a customer and an account assigned to that customer and may further identify the contactless card 300 associated with the customer's account.

The processor 330 and memory 335 elements of the foregoing exemplary embodiments are described with reference to the contact pad 320, but the present disclosure is not limited thereto. It is understood that these elements may be implemented outside of the contact pad 320 or entirely separate from it, or as further elements in addition to the processor 330 and the memory 335 elements located within the contact pad 320.

In some examples, the contactless card 300 may comprise one or more antennas 355. The one or more antennas 355 may be placed within the contactless card 300 and around the processing circuitry 325 of the contact pad 320. For example, the one or more antennas 355 may be integral with the processing circuitry 325 and the one or more antennas 355 may be used with an external booster coil. As another example, the one or more antennas 355 may be external to the contact pad 320 and the processing circuitry 325.

In an embodiment, the coil of contactless card 300 may act as the secondary of an air core transformer. A terminal (such as the first device 110) may communicate with the contactless card 300 by cutting power or amplitude modulation. The contactless card 300 may infer the data transmitted from the terminal using the gaps in the contactless card's power connection, which may be functionally maintained through one or more capacitors. The contactless card 300 may communicate back by switching a load on the contactless card's coil or load modulation. Load modulation may be detected in the terminal's coil through interference.

As explained above, the contactless card 300 may be built on a software platform operable on smart cards or other devices having limited memory, such as JavaCard, and one or more or more applications or applets (applet 340) may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader (the first device 110), and produce an NDEF message that comprises a cryptographically secure OTP encoded as an NDEF text tag.

The contactless card 300 may be configured for communication with the first device 110 via a communication interface configured for establishing communication with the first device 110. The communication interface may be configured for contact-based communication, in which case the interface may have electrical circuitry and contact pads on the surface of the card 300 for establishing direct electrical communication between the card 300 and the first device 110. Alternatively or in addition, the communication interface may be configured for contactless communication with the first device 110. In such embodiments, the communication interface may be or include an NFC communication interface configured for communication with other NFC communication devices when the card 300 is within a predetermined NFC range. In some embodiments, the card 300 may include a second communication interface configured for establishing short range communication with the first device 110 via Bluetooth, or other short range communication methodology. In such embodiments, the card 300 may have a short range communication antenna that is included in or connected to the short range communication interface. The card 300 may also include a power management system for use in managing the distribution of power during an NFC transaction.

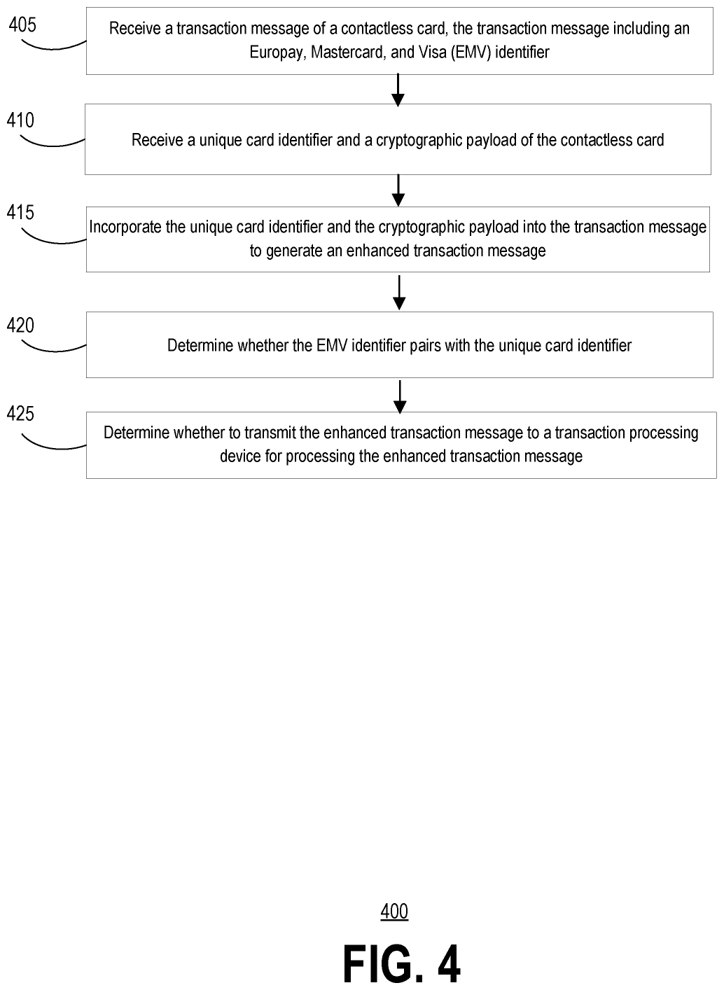

FIG. 4 illustrates a flow chart of an example method 400 for enhancing transaction messages for fraud prevention according to an example embodiment. FIG. 4 may reference the same or similar components as those illustrated in FIGS. 1-3, including a first device, a server, a database, a second device, and a contactless card. The method 400 can be implemented in the system 100 and may include, but is not limited to, the following steps.

At step 405, the server 130 may receive a transaction message of the contactless card 160. The transaction message may include an Europay, Mastercard, and Visa (EMV) identifier. The transaction message may comprise the payment information of the contactless card 160 (e.g., credit card number, cardholder name, and card expiration date and/or security code on the card). The payment information can be incorporated into the transaction message through reading the card directly by a PoS or mobile phone, obtaining a virtual card number of the card, or manually entering the card number.

At step 410, the server 130 may receive a unique card identifier and a cryptographic payload of the contactless card 160. For example, the contactless card 160 may be prompted to tap to the first device 110, and in response, the first device 110 can receive from the contactless card 160 a unique card identifier and a cryptographic payload. The cryptographic payload may include, for example, security information (e.g., a cryptogram) encrypted by the contactless card 160 using a private key unique to the contactless card 160 that is known only to the card account administrator (e.g., the server 130). The first device 110 can transmit the unique card identifier and the cryptographic payload to the server 130.

At step 415, the server 130 may incorporate the unique card identifier and the cryptographic payload into the transaction message to generate an enhanced transaction message. The transaction message is a transaction message format supported by the ISO20022 transaction standard, which was adopted in 2021. The ISO20022 transaction standard is XML based and more flexible than previous standards. For example, the server 130, which may be associated with the merchant's payment processor, can incorporate the unique card identifier and the cryptographic payload into the ISO20022 transaction message along with normal transaction data (e.g., the payment information and an EMV identifier of the contactless card 160).

At step 420, the server 130 may determine whether the EMV identifier pairs with the unique card identifier. For example, the server 130 may consult the database 140 to see whether the EMV identifier has been paired with the unique card identifier in the past. If the EMV identifier and the unique card identifier matches, the server 130 can determine the EMV identifier pairs with the unique card identifier. If the EMV identifier is a new EMV identifier, the server 130 may determine the EMV identifier does not pair with the unique card identifier, and may then determine the transaction associated with the enhanced transaction message is a fraudulent transaction.

At step 425, the server 130 may determine whether to transmit the enhanced transaction message to a transaction processing device for processing the enhanced transaction message. For example, if the server 130 determines the EMV identifier pairs with the unique card identifier, which can indicate the transaction is a valid transaction, the server 130 can transmit the enhanced transaction message to the transaction processing device for processing the enhanced transaction message. Otherwise, the server 130 can determine the transaction is a fraudulent transaction and does not transmit the enhanced transaction message to the transaction processing device for processing the enhanced transaction message.

In some embodiments, if the server 130 is associated with the issuer of the contactless card 160, the server 130 may not need to transmit the enhanced transaction message to the transaction processing device for processing the enhanced transaction message. Instead, the server 130 may be able to process the enhanced transaction message to execute the transaction.

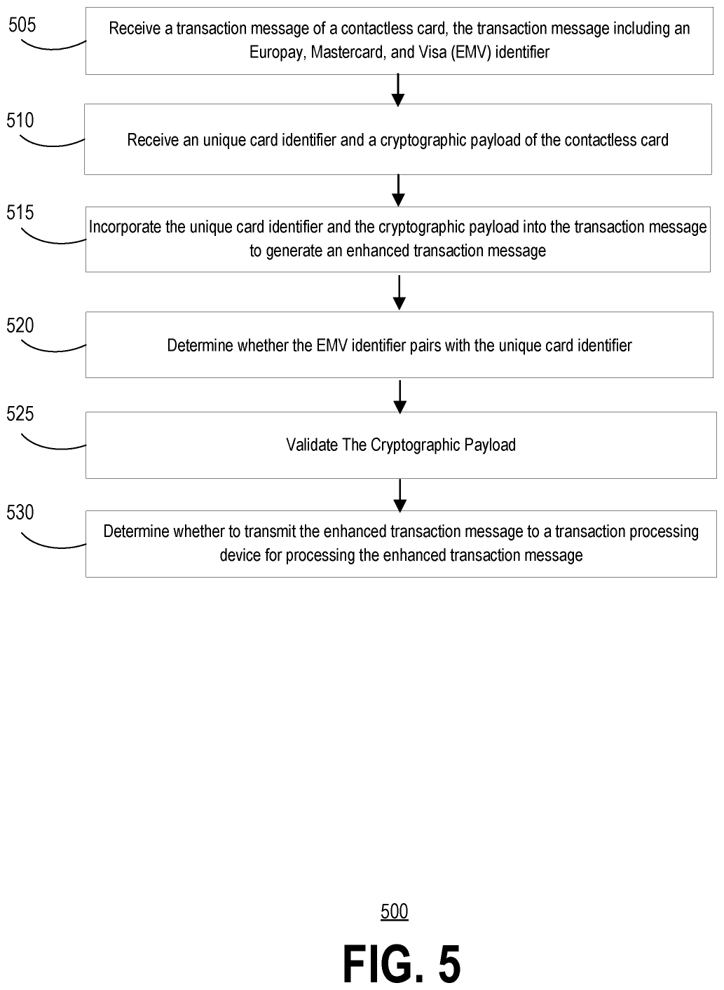

FIG. 5 illustrates a flow chart of an example method 500 for enhancing transaction messages for fraud prevention according to an example embodiment. FIG. 5 may reference the same or similar components as those illustrated in FIGS. 1-4, including a first device, a server, a database, a second device, and a contactless card. The method 500 can be implemented in the system 100 and may include, but is not limited to the following steps.

At step 505, the server 130 may receive a transaction message of the contactless card 160. The transaction message may include an Europay, Mastercard, and Visa (EMV) identifier. The transaction message may comprise the payment information of the contactless card 160 (e.g., credit card number, cardholder name, and card expiration date and/or security code on the card). The payment information can be incorporated into the transaction message through reading the card directly by a PoS or mobile phone, obtaining a virtual card number of the card, or manually entering the card number.

At step 510, the server 130 may receive a unique card identifier and a cryptographic payload of the contactless card 160. For example, the contactless card 160 may be prompted to tap to the first device 110, and in response, the first device 110 can receive from the contactless card 160 a unique card identifier and a cryptographic payload. The cryptographic payload may include, for example, security information (e.g., a cryptogram) encrypted by the contactless card 160 using a private key unique to the contactless card 160 that is known only to the card account administrator (e.g., the server 130). The first device 110 can transmit the unique card identifier and the cryptographic payload to the server 130.

At step 515, the server 130 may incorporate the unique card identifier and the cryptographic payload into the transaction message to generate an enhanced transaction message. The transaction message is a transaction message format supported by the ISO20022 transaction standard, which was adopted in 2021. The ISO20022 transaction standard is XML based and more flexible than previous standards. For example, the server 130, which may be associated with the merchant's payment processor, can incorporate the unique card identifier and the cryptographic payload into the ISO20022 transaction message along with normal transaction data (e.g., the payment information and an EMV identifier of the contactless card 160).

At step 520, the server 130 may determine whether the EMV identifier pairs with the unique card identifier. For example, the server 130 may consult the database 140 to see whether the EMV identifier has been paired with the unique card identifier in the past. If the EMV identifier and the unique card identifier matches, the server 130 can determine the EMV identifier pairs with the unique card identifier. If the EMV identifier is a new EMV identifier, the server 130 may determine the EMV identifier does not pair with the unique card identifier, and may then determine the transaction associated with the enhanced transaction message is a fraudulent transaction.

At step 525, the server 130 may further validate the cryptographic payload. The cryptographic payload includes a cryptogram. For example, the server 130 may generate another cryptogram based on information that is associated with the contactless card 160 and retrieved from the database 140. The server 130 may then compare the generated cryptogram with the received cryptogram from the cryptographic payload. If these two cryptograms are the same, the server 130 can determine this transaction is a real transaction, otherwise, it is determined to be a fraudulent transaction. The server 130 may also decrypt the cryptogram and extract the unique card identifier of the contactless card 160 that is also encrypted into the cryptogram. When the server 130 receives the cryptogram, the server may further decrypt the cryptogram after verifying and/or validating the cryptogram. The server 130 may then extract the unique card identifier of the contactless card 160. The server 130 may verify the unique card identifier of the contactless card 160 by searching the database 140. The server 130 may authenticate the user based on the unique card identifier of the contactless card 160. Validation of the cryptogram is not limited to generating another cryptogram on the back end by the sever 130, but validating the cryptogram generated by the contactless card 160 can only be done by the contactless card 160, which can be done by validating a signature or Message Authentication code.

At step 530, the server 130 may determine whether to transmit the enhanced transaction message to a transaction processing device for processing the enhanced transaction message. For example, if the server 130 determines the EMV identifier pairs with the unique card identifier, which can indicate the transaction is a valid transaction, the server 130 can transmit the enhanced transaction message to the transaction processing device for processing the enhanced transaction message. Further, the server 130 may determine whether to transmit the enhanced transaction message to the transaction processing device for processing the enhanced transaction message, based on whether the cryptographic payload is validated at step 525. If the cryptographic payload is validated, the server 130 can transmit the enhanced transaction message to the transaction processing device for processing the enhanced transaction message. Otherwise, the server 130 can determine the transaction is a fraudulent transaction and does not transmit the enhanced transaction message to the transaction processing device for processing the enhanced transaction message.

In some embodiments, if the server 130 is associated with the issuer of the contactless card 160, the server 130 may not need to transmit the enhanced transaction message to the transaction processing device for processing the enhanced transaction message. Instead, the server 130 may be able to process the enhanced transaction message to complete the transaction.

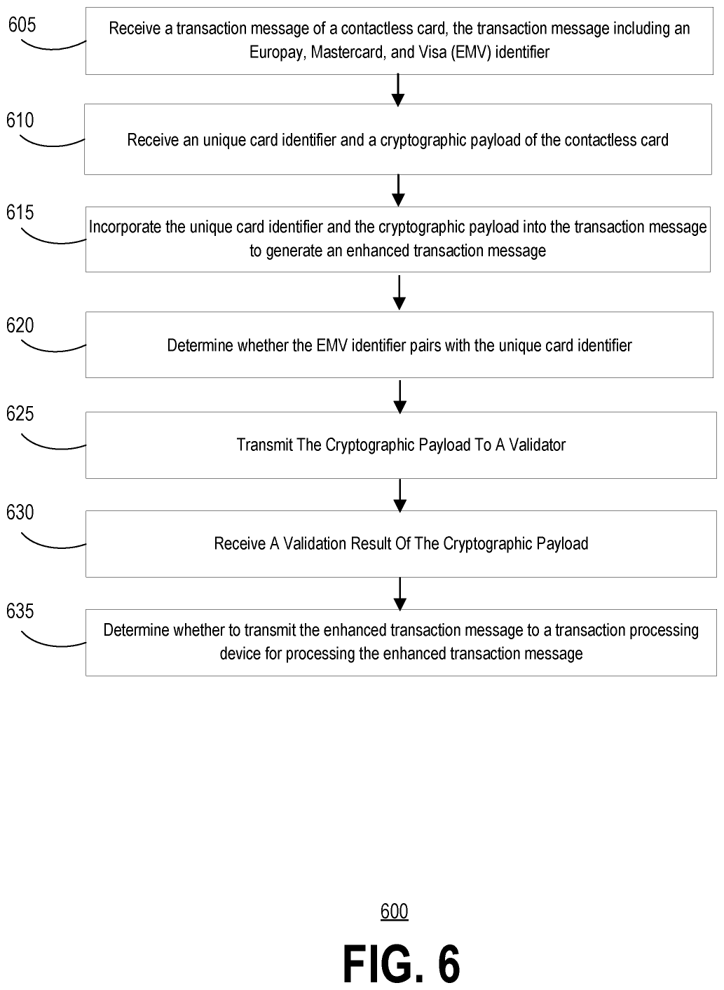

FIG. 6 illustrates a flow chart of an example method 600 for enhancing transaction messages for fraud prevention according to an example embodiment. FIG. 6 may reference the same or similar components as those illustrated in FIGS. 1-5, including a first device, a server, a database, a second device, and a contactless card. The method 600 can be implemented in the system 100 and may include, but is not limited to the following steps.

At step 605, the server 130 may receive a transaction message of the contactless card 160. The transaction message may include an Europay, Mastercard, and Visa (EMV) identifier. The transaction message may comprise the payment information of the contactless card 160 (e.g., credit card number, cardholder name, and card expiration date and/or security code on the card). The payment information can be incorporated into the transaction message through reading the card directly by a PoS or mobile phone, obtaining a virtual card number of the card, or manually entering the card number.

At step 610, the server 130 may receive a unique card identifier and a cryptographic payload of the contactless card 160. For example, the contactless card 160 may be prompted to tap to the first device 110, and in response, the first device 110 can receive from the contactless card 160 a unique card identifier and a cryptographic payload. The cryptographic payload may include, for example, security information (e.g., a cryptogram) encrypted by the contactless card 160 using a private key unique to the contactless card 160 that is known only to the card account administrator (e.g., the server 130). The first device 110 can transmit the unique card identifier and the cryptographic payload to the server 130. In some embodiments, the generation of the authenticity token (MAC or signature) can also be done with public key algorithms.

At step 615, the server 130 may incorporate the unique card identifier and the cryptographic payload into the transaction message to generate an enhanced transaction message. The transaction message is a transaction message format supported by ISO20022 transaction standard, which was adopted in 2021. The ISO20022 transaction standard is XML based and more flexible than previous standards. For example, the server 130, which may be associated with the merchant's payment processor, can incorporate the unique card identifier and the cryptographic payload into the ISO20022 transaction message along with normal transaction data (e.g., the payment information and an EMV identifier of the contactless card 160).

At step 620, the server 130 may determine whether the EMV identifier pairs with the unique card identifier. For example, the server 130 may consult the database 140 to see whether the EMV identifier has been paired with the unique card identifier in the past. If the EMV identifier and the unique card identifier matches, the server 130 can determine the EMV identifier pairs with the unique card identifier. If the EMV identifier is a new EMV identifier, the server 130 may determine the EMV identifier does not pair with the unique card identifier, and may then determine the transaction associated with the enhanced transaction message is a fraudulent transaction.

At step 625, the server 130 may transmit the cryptographic payload to a validator for validating the cryptographic payload. Additionally, the server 130 may also transmit the issuer identifier of the issuing bank of the contactless card 160 to the validator, such that the validator can associate the issuer identifier of the issuing bank with the cryptographic payload when performing a validation and/or returning a validation result. The cryptographic payload includes a cryptogram. For example, the validator may generate another cryptogram based on information that is associated with the contactless card 160 and retrieved from the database 140. The validator may then compare the generated cryptogram with the received cryptogram from the cryptographic payload. If these two cryptograms are the same, the cryptographic payload can be validated. The validator may transmit a validation result of the cryptographic payload back to the server 130 along with the issuer identifier.

At step 630, the server 130 may receive the validation result of the cryptographic payload along with the issuer identifier from the validator. The validation result can indicate whether the cryptographic payload has been validated.

At step 635, the server 130 may determine whether to transmit the enhanced transaction message to a transaction processing device for processing the enhanced transaction message. For example, if the server 130 determines the EMV identifier pairs with the unique card identifier, which can indicate the transaction is a valid transaction, the server 130 can transmit the enhanced transaction message to the transaction processing device for processing the enhanced transaction message. Further, the server 130 may determine whether to transmit the enhanced transaction message to the transaction processing device for processing the enhanced transaction message, based on whether the cryptographic payload is validated at step 630. If the cryptographic payload is validated, the server 130 can transmit the enhanced transaction message to the transaction processing device for processing the enhanced transaction message. Otherwise, the server 130 can determine the transaction is a fraudulent transaction and does not transmit the enhanced transaction message to the transaction processing device for processing the enhanced transaction message. The transaction processing device can be a device associated with the issuing bank of the contactless card 160.

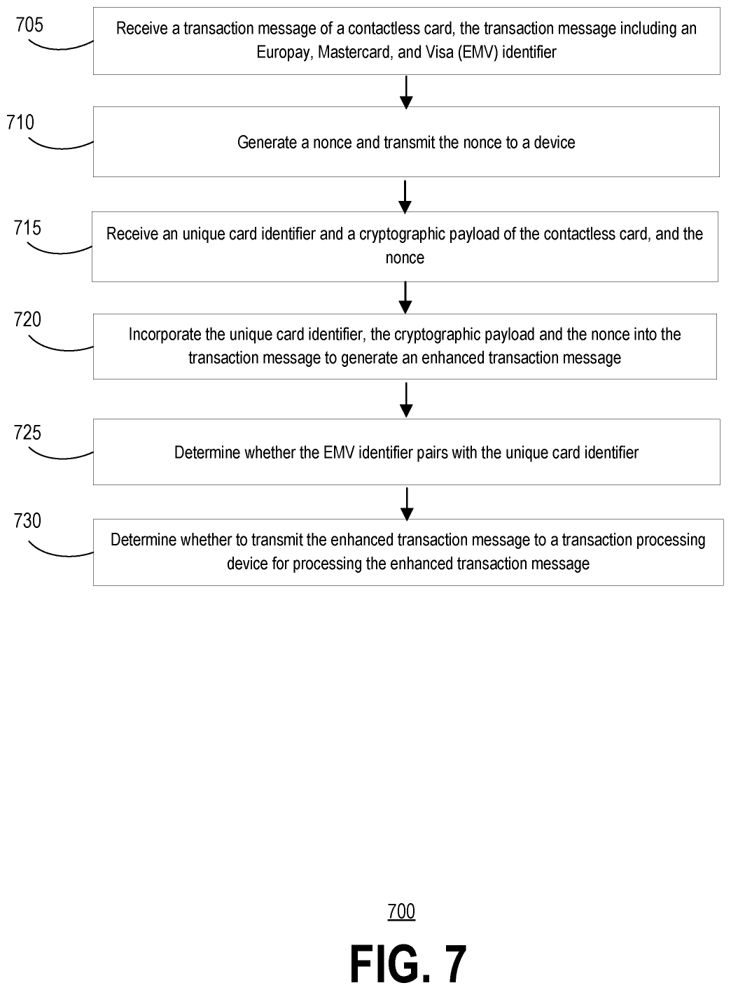

FIG. 7 illustrates a flow chart of an example method 700 for enhancing transaction messages for fraud prevention according to an example embodiment. FIG. 7 may reference the same or similar components as those illustrated in FIGS. 1-6, including a first device, a server, a database, a second device, and a contactless card. The method 700 can be implemented in the system 100 and may include, but is not limited to the following steps.

At step 705, the server 130 may receive a transaction message of the contactless card 170. The transaction message may include an Europay, Mastercard, and Visa (EMV) identifier. The transaction message may comprise the payment information of the contactless card 170 (e.g., credit card number, cardholder name, and card expiration date and/or security code on the card). The payment information can be incorporated into the transaction message through reading the card directly by a PoS or mobile phone, obtaining a virtual card number of the card, or manually entering the card number.

At step 710, the server 130 may generate a nonce and transmit the nonce to the first device 110 upon tapping the contactless card 160 to the first device 110. The nonce can be a counter, for example. As used herein, nonce stands for Number Used Once, and it can be unpredictable, so someone cannot guess what the next session nonce will be. In some embodiments, the nonce is to be included in the generation of the cryptogram (MAC or encrypted value) so the validator can verify that the cryptogram was generated with the current nonce.

At step 715, the server 130 may receive a unique card identifier, a cryptographic payload of the contactless card 160 and the nonce. For example, the contactless card 160 may be prompted to tap to the first device 110, and in response, the first device 110 can receive from the contactless card 160 a unique card identifier and a cryptographic payload. The cryptographic payload may include, for example, security information (e.g., a cryptogram) encrypted by the contactless card 160 using a private key unique to the contactless card 160 that is known only to the card account administrator (e.g., the server 130). The first device 110 can transmit the unique card identifier and the cryptographic payload to the server 130.

At step 720, the server 130 may incorporate the unique card identifier, the cryptographic payload, and the nonce into the transaction message to generate an enhanced transaction message. The transaction message is a transaction message format supported by ISO20022 transaction standard, which was adopted in 2021. The ISO20022 transaction standard is XML based and more flexible than previous standards. For example, the server 130, which may be associated with the merchant's payment processor, can incorporate the unique card identifier and the cryptographic payload into the ISO20022 transaction message along with normal transaction data (e.g., the payment information and an EMV identifier of the contactless card 160).

At step 725, the server 130 may determine whether the EMV identifier pairs with the unique card identifier. For example, the server 130 may consult the database 140 to see whether the EMV identifier has been paired with the unique card identifier in the past. If the EMV identifier and the unique card identifier matches, the server 130 can determine the EMV identifier pairs with the unique card identifier. If the EMV identifier is a new EMV identifier, the server 130 may determine the EMV identifier does not pair with the unique card identifier, and may then determine the transaction associated with the enhanced transaction message is a fraudulent transaction.

At step 730, the server 130 may determine whether to transmit the enhanced transaction message to a transaction processing device for processing the enhanced transaction message. For example, if the server 130 determines the EMV identifier pairs with the unique card identifier, which can indicate the transaction is a valid transaction, the server 130 can transmit the enhanced transaction message to the transaction processing device for processing the enhanced transaction message. Otherwise, the server 130 can determine the transaction is a fraudulent transaction and does not transmit the enhanced transaction message to the transaction processing device for processing the enhanced transaction message. The transaction processing device can be a device associated with the issuing bank of the contactless card 160.

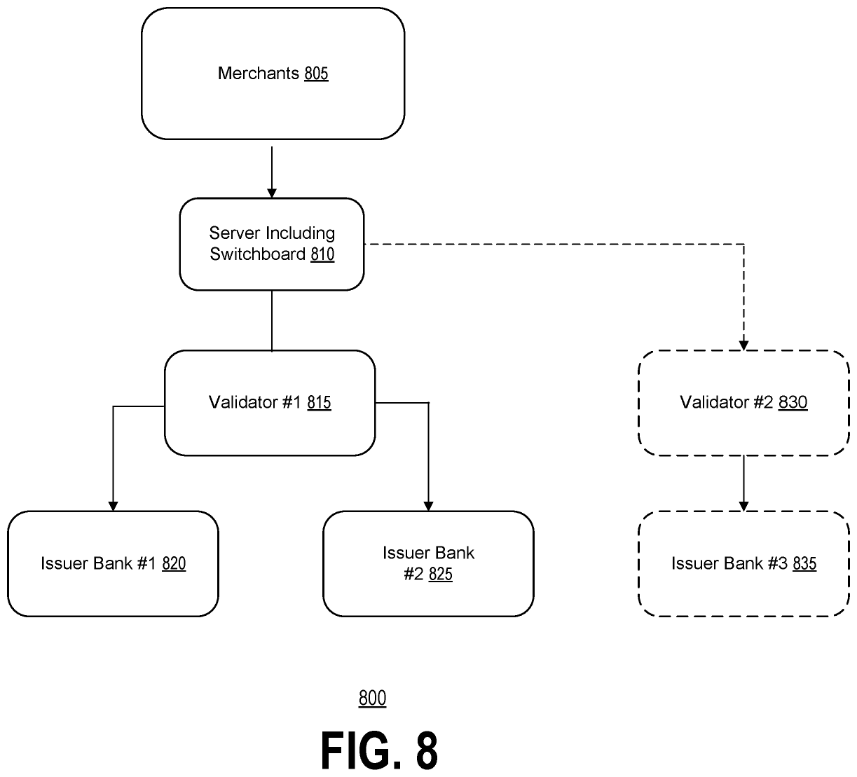

FIG. 8 illustrates a diagram of a system 800 for enhancing transaction messages for fraud prevention according to an example embodiment. The system 800 may comprise a merchant device associated with merchant 805, a server including a switchboard 810, a first validator 815, a first bank device associated with a first issuer bank 820, a second bank device associated with a second issuer bank 825, a second validator 830, and a third bank device associated with a third issuer bank 835.

In the system 800, the server including the switchboard 810 may receive from the merchant device associated with merchant 805 (e.g., a PoS of the merchant) a unique card identifier, a cryptographic payload, an issuer identifier of an issuing bank, and a transaction message including payment information of a contactless card. The merchant as used herein can refer to any entity that provides customers with services, subscriptions, products, consultancies or other merchandises. The server including the switchboard 810 may combine the unique card identifier, the cryptographic payload, the issuer identifier of an issuing bank, and the transaction message into an enhanced transaction message, and transmit the enhanced transaction message to a validator. The server including the switchboard 810 may choose a validator for validating the cryptographic payload from the first validator 815 and the second validator 830, based on past transactions, the issuer identifier of the issuing bank, and/or workload of the first validator 815 and the second validator 830. After the chosen validator validates the cryptographic payload, the chosen validator may transmit the enhanced transaction message along with the validation result to the issuing bank (e.g., to the first bank device associated with the first issuer bank 820, the second bank device associated with the second issuer bank 825, or the third bank device associated with the third issuer bank 835) associated with the issuer identifier for executing the transaction. Alternatively, the chosen validator may transmit the validation result back to the server including the switchboard 810. The server including the switchboard 810 can then transmit the enhanced transaction message along with the validation result to the issuing bank (e.g., to the first bank device associated with the first issuer bank 820, the second bank device associated with the second issuer bank 825, or the third bank device associated with the third issuer bank 835) associated with the issuer identifier for executing the transaction.

In some embodiments, upon validating the cryptographic payload, the validator may generate an access token and send the access token back to the switchboard. The access token can indicate the cryptographic payload has been successfully validated. The server including the switchboard 810 can then transmit the enhanced transaction message along the access token to the issuing bank (e.g., to the first bank device associated with the first issuer bank 820, the second bank device associated with the second issuer bank 825, or the third bank device associated with the third issuer bank 835) associated with the issuer identifier for executing the transaction. If the chosen validator and the issuer bank are the same institution, the server including the switchboard 810 can then pass the enhanced transaction message pass to the issuer bank, and the issuer bank would then internally validate the cryptographic payload and then process the transaction.

In some aspects, the techniques described herein relate to a system of fraud prevention, including: a server including a memory and a processor, wherein the server is configured to: receive a transaction message of a contactless card, the transaction message including an Europay, Mastercard, and Visa (EMV) identifier, receive a unique card identifier and a cryptographic payload of the contactless card, incorporate the unique card identifier and the cryptographic payload into the transaction message to generate an enhanced transaction message, determine whether the EMV identifier pairs with the unique card identifier, and determine whether to transmit the enhanced transaction message to a transaction processing device for processing the enhanced transaction message.

In some aspects, the techniques described herein relate to a system, wherein the transaction message is an Extensible Markup Language (XML)-supported message.

In some aspects, the techniques described herein relate to a system, wherein the transaction message includes an issuer identifier associated with the contactless card.

In some aspects, the techniques described herein relate to a system, wherein the cryptographic payload includes a cryptogram generated by the contactless card.

In some aspects, the techniques described herein relate to a system, wherein the contactless card is a near-field communication (NFC)-enabled card.

In some aspects, the techniques described herein relate to a system, wherein the server is further configured to: generate a nonce, and transmit the nonce to a user device.

In some aspects, the techniques described herein relate to a system, wherein the determining whether the EMV identifier pairs with the unique card identifier includes determining whether the EMV identifier has been paired with the unique card identifier in the past.

In some aspects, the techniques described herein relate to a system, wherein the server is further configured to validate the cryptographic payload.

In some aspects, the techniques described herein relate to a system, wherein the server is further configured to: transmit the cryptographic payload to a validator, and receive a validation result from the validator.

In some aspects, the techniques described herein relate to a system, wherein the validation result indicates that the cryptographic payload fails to be validated, and the server is further configured to not transmit the enhanced transaction message to the transaction processing device.

In some aspects, the techniques described herein relate to a system, wherein the cryptographic payload is validated by the transaction processing device.

In some aspects, the techniques described herein relate to a method of fraud prevention, including: receiving a transaction message of a contactless card, the transaction message including an Europay, Mastercard, and Visa (EMV) identifier; receiving a unique card identifier and a cryptographic payload of the contactless card; incorporating the unique card identifier and the cryptographic payload into the transaction message to generate an enhanced transaction message; determining whether the EMV identifier pairs with the unique card identifier; and determining whether transmit the enhanced transaction message to a transaction processing device for processing the enhanced transaction message.

In some aspects, the techniques described herein relate to a method, wherein the transaction message is an ISO20022-supported message.

In some aspects, the techniques described herein relate to a method, wherein the unique card identifier and the cryptographic payload are received via near-field communication (NFC) from the contactless card.

In some aspects, the techniques described herein relate to a method, further including: validating the cryptographic payload; and transmitting the enhanced transaction message to the transaction processing device.

In some aspects, the techniques described herein relate to a method, further including: generating an issuer identifier associated with the contactless card; and incorporating the issuer identifier into to the enhanced transaction message.

In some aspects, the techniques described herein relate to a method, further including: transmitting the issuer identifier, the unique card identifier, and the cryptographic payload to a validator; and receiving a validation result of the cryptographic payload from the validator.

In some aspects, the techniques described herein relate to a method, wherein: the validation result indicates that the cryptographic payload is successfully validated, and includes an access token, and the method further includes: incorporating the access token into the enhanced transaction message, and transmitting the enhanced transaction message to the transaction processing device.

In some aspects, the techniques described herein relate to a method, wherein the issuer identifier is associated with the transaction processing device.

In some aspects, the techniques described herein relate to a non-transitory, computer-readable medium including instructions for fraud prevention that, when executed on a computer arrangement, perform actions including: receiving a transaction message of a contactless card, the transaction message including an Europay, Mastercard, and Visa (EMV) identifier; receiving a unique card identifier and a cryptographic payload of the contactless card; incorporating the unique card identifier and the cryptographic payload into the transaction message to generate an enhanced transaction message; determining whether the EMV identifier pairs with the unique card identifier; and determining whether to transmit the enhanced transaction message to a transaction processing device for processing the enhanced transaction message.

Throughout the disclosure, the term “merchant” is used, and it is understood that the present disclosure is not limited to a particular merchant or type of merchant. Rather, the present disclosure includes any type of merchant, vendor, or other entity involved in activities where products or services are sold or otherwise provided.

Throughout the disclosure, the terms “bank” or “issuer bank” are used, and it is understood that the present disclosure is not limited to a particular bank or type of bank. Rather, the present disclosure includes any type of bank, account and/or card issuer, or other entity involved in the creation, issuance, or provisioning of accounts or cards associated with accounts.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a first device, a user device, a server, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of fraud prevention, comprising:
a server including a memory and a processor,
wherein the server is configured to:
receive a transaction message of a contactless card, the transaction message including an Europay, Mastercard, and Visa (EMV) identifier,
receive a unique card identifier and a cryptographic payload of the contactless card,
incorporate the unique card identifier and the cryptographic payload into the transaction message to generate an enhanced transaction message,
determine whether the EMV identifier pairs with the unique card identifier, and
determine whether to transmit the enhanced transaction message to a transaction processing device for processing the enhanced transaction message.

2. The system according to claim 1, wherein the transaction message is an Extensible Markup Language (XML)-supported message.

3. The system according to claim 1, wherein the transaction message includes an issuer identifier associated with the contactless card.

4. The system according to claim 1, wherein the cryptographic payload includes a cryptogram generated by the contactless card.

5. The system according to claim 1, wherein the contactless card is a near-field communication (NFC)-enabled card.

6. The system according to claim 1, wherein the server is further configured to:
generate a nonce, and
transmit the nonce to a user device.

7. The system according to claim 1, wherein the determining whether the EMV identifier pairs with the unique card identifier includes determining whether the EMV identifier has been paired with the unique card identifier in the past.

8. The system according to claim 1, wherein the server is further configured to validate the cryptographic payload.

9. The system according to claim 1, wherein the server is further configured to:
transmit the cryptographic payload to a validator, and
receive a validation result from the validator.

10. The system according to claim 9, wherein
the validation result indicates that the cryptographic payload fails to be validated, and
the server is further configured to not transmit the enhanced transaction message to the transaction processing device.

11. The system according to claim 1, wherein the cryptographic payload is validated by the transaction processing device.

12. A method of fraud prevention, comprising:
receiving a transaction message of a contactless card, the transaction message including an Europay, Mastercard, and Visa (EMV) identifier;
receiving a unique card identifier and a cryptographic payload of the contactless card;
incorporating the unique card identifier and the cryptographic payload into the transaction message to generate an enhanced transaction message;
determining whether the EMV identifier pairs with the unique card identifier; and
determining whether transmit the enhanced transaction message to a transaction processing device for processing the enhanced transaction message.

13. The method according to claim 12, wherein the transaction message is an ISO20022-supported message.

14. The method according to claim 12, wherein the unique card identifier and the cryptographic payload are received via near-field communication (NFC) from the contactless card.

15. The method according to claim 12, further comprising:
validating the cryptographic payload; and
transmitting the enhanced transaction message to the transaction processing device.

16. The method according to claim 12, further comprising:
generating an issuer identifier associated with the contactless card; and
incorporating the issuer identifier into to the enhanced transaction message.

17. The method according to claim 16, further comprising:
transmitting the issuer identifier, the unique card identifier, and the cryptographic payload to a validator; and
receiving a validation result of the cryptographic payload from the validator.

18. The method according to claim 17, wherein:
the validation result indicates that the cryptographic payload is successfully validated, and includes an access token, and
the method further comprises:
incorporating the access token into the enhanced transaction message, and
transmitting the enhanced transaction message to the transaction processing device.

19. The method according to claim 16, wherein the issuer identifier is associated with the transaction processing device.

20. A non-transitory, computer-readable medium comprising instructions for fraud prevention that, when executed on a computer arrangement, perform actions comprising:
receiving a transaction message of a contactless card, the transaction message including an Europay, Mastercard, and Visa (EMV) identifier;
receiving a unique card identifier and a cryptographic payload of the contactless card;
incorporating the unique card identifier and the cryptographic payload into the transaction message to generate an enhanced transaction message;
determining whether the EMV identifier pairs with the unique card identifier; and
determining whether to transmit the enhanced transaction message to a transaction processing device for processing the enhanced transaction message.
